(19) United States
(12) Patent Application Publication
(10) Pub. No.: US 2010/0325019 A1
(43) Pub. Date: Dec. 23, 2010

(54) SYSTEM AND PROCESS FOR DOCUMENTING NETWORK ASSETS

(75) Inventor: Paul Avery, Blairstown, NJ (US)

Correspondence Address: GIFFORD, KRASS, SPRINKLE,ANDERSON & CITKOWSKI, P.C, PO BOX 7021, TROY, MI, 48007-7021, US

(73) Assignee: AlphapointTechnology

(21) Appl. No.: 12/761,861

(22) Filed: Apr. 16, 2010

Related U.S. Application Data
(60) Provisional application No. 61/170,279, filed on Apr. 17, 2009.

(51) Int. Cl. G06Q 10/00

(52) U.S. Cl. 705/28

(57) ABSTRACT

A system for asset inventory and management that includes a data input module, an asset storage database, a search module, and a display module is provided. The data input module can be used to input asset data, location data, and container data, the location data and the container data associated with the asset data. The asset storage database can have asset data and/or location data stored therewithin and the search module can search for and select at least part of the asset data and the location data as a function of one or more input search parameters. The display module can display at least part of the asset data and the location data selected by the search module.

### CROSS-REFERENCE TO RELATED APPLICATION

This application claims priority of U.S. Provisional Patent Application Ser. No. 61/170,279 filed Apr. 17, 2009, entitled “System and Method for Documenting Network Assets”, which is incorporated herein by reference.

### FIELD OF THE INVENTION

The invention relates to a system and process for gathering and presenting to a user information about the assets of an organization, and in particular, a system and process for administering the ongoing documentation of network assets of the organization, including any new additions, moves and changes associated with the assets; the system and process of the invention operable to enable the inventorying and management of the assets while providing wide and rapid access to the information.

### BACKGROUND OF THE INVENTION

Many organizations have a large number of equipment assets interconnected into systems that are in constant use. Examples of such systems include, but are not limited to, computer networks, data and telecommunications networks, network operations centers, radio and television studios and broadcast centers, power generating plants, manufacturing assembly lines, chemical processing plants, semiconductor processing plants, pharmaceutical processing, military installations and shipboard installations.

Typically the assets are clustered into equipment or machine rooms where they are housed in tall racks or placed on shelves. New or hastily added equipment may also be placed anywhere there is room, including on or below tables and desks.

The assets can be interconnected using a variety of wires, cables, pipes or other types of interconnections. The combination of all assets and interconnections taken together can be thought of as a “physical system.” The way the assets are interconnected with one another can be thought of as a “logical system.” A single logical connection between two assets may actually involve numerous physical interconnections.

To perform routine maintenance, upgrades, troubleshooting, repairs and replacements, the owner must know where assets are physically located, i.e., the configuration and location of the physical system. This may be done through the use of location diagrams or maps. Such diagrams can range from very formal “official” documents to hand-drawn sketches kept by individuals. Frequently these diagrams are out of date, and often they exist only in the minds of the people assigned to maintain the system.

Similarly, to plan for events such as maintenance, owners must understand the logical system of their network. This is often recorded on schematics or block diagrams. These diagrams show the logical relationships between the assets but not necessarily any physical location information.

Owners also need to know the technical characteristics of each asset and interconnection present in the network. This may include, for example, the manufacturer's specifications and any owner defined technical settings which are a function of the asset, such as the Internet Protocol (“IP”) address for a computer, flow rate for a pump, speed for a motor, etc.

For inventory management, accounting and other business purposes, the owners must know what assets they have in active use, what assets are in storage, and the various characteristics of each asset. This information is often recorded in a variety of documents, each of which has a specific purpose and each containing only the information needed for that purpose. This leads to multiple documents, which have some, but not all of the information about a subset of the assets. Typically, the knowledge here described is woefully inadequate, fragmented, out of date and poorly maintained.

The present invention is directed to system and process for network management that solves some of the deficiencies described above and provides users with an interface for obtaining and modifying a plurality of information regarding the network and its various components.

### SUMMARY OF THE INVENTION

A system for asset inventory and management for one or more networks that can include a data input module, an asset storage database, a search module, and/or a display module is provided. The data input module can be used to input asset data, location data, and container data, the location data and the container data associated with the asset data. The asset storage database can have asset data and/or location data stored therewithin and the search module can search for and select at least part of the asset data and/or location data as a function of one or more input search parameters. The display module can display at least part of the asset data and/or location data selected by the search module.

In addition to searching for asset data, the search module can search for free space and reserved free space that is part of the asset inventory and management system. In some instances, the free space and the reserved free space can be included within the system as an asset. In addition, a reserve free space module can be included that affords for reserving at least part of the free space that is part of the asset inventory and management system.

Additional modules can be included within the system such as a diagram module, a sub-systems module, a location module, a collection module, a preference module, a report module, a connectivity module and/or a statistics module. The diagram module can provide a schematic diagram of a sub-system within the system, a schematic map with or without photographs illustrating one or more physical locations having assets, a floor plan of a building at a particular location, a room plan that is on a given floor, an electronic or electrical diagram of an asset, and the like. The sub-systems module can provide a list of assets, links, and the like of a given subsystem that is contained within a network used by an individual, company, corporation, and the like that is stored within the system.

The location module can provide a tabular list of locations and/or graphical display where one or more assets within the system is stored and/or located and the collection module can provide a tabular list or graphical display of a collection of assets that belong to a certain group, department, organization, and the like. In addition, location data can include location information associated with a receiving location, a storage location, an inventory location, a decommissioned location, a building, a floor within a building, a room on a floor, a rack within a room, a table within a room, and the like. In addition, the container data can include information related to a cabinet, a rack, predefined floor space, a freestanding desk, a bench, a table, etc.

The preference module can provide a list of preferred vendors, preferred equipment, preferences in how certain assets are connected and/or stored, and the like. The report module can provide a tabular or graphical report on such items as total number of assets within the system, power used by one or more assets located in one or more locations, a list of upcoming warranty expiration dates, a list of upcoming lease expiration dates, a list of purchase dates, and the like. The connectivity module can provide a schematic diagram of all the assets linked to a predetermined asset and/or all the assets linked between two or more assets. In addition, the connectivity module can provide information on the links between one or more assets.

In some instances, the asset data can include computer equipment data, telecommunication equipment data, free space data, and reserved space data. For example and for illustrative purposes only, the asset data can include an asset name, a manufacturer of an asset, an asset model, an asset type, a number of slots contained within an asset, an asset serial number, an asset IP address, a specific power used by an asset, a sub-system that an asset belongs to, a contact name for an asset, a contact phone number for an asset, a contact email for an asset, a container such as rack where an asset is located, a room where an asset is located, a parent asset of an asset, a grandparent asset of an asset, a general location of an asset, a description of an asset, a real-time status of an asset, ping information of an asset, a purchase date for an asset, a purchase price for an asset, lease information for an asset, maintenance information for an asset, warranty information for an asset, warranty expiration date for an asset, an asset ID, and the like.

One or more technical business rules can be included within the system and be operable to define whether or not a second asset type can be nested within a first asset type. In addition, one or more of the technical business rules can define which of one or more asset types can be inserted within a given slot of an asset, a container, etc., and may or may not define which of one or more link types can be inserted within a given slot of an asset. A first asset type can include a computer, a server, a router, a printer, a copier, and/or a telephone. A second asset type can include a control unit device, an arithmetic/logic unit device, a memory device, and/or an input/output device.

The display module can display a schematic representation of a predetermined rack with predetermined assets attached to the rack and the search module is operable to search for and find free space within the system as a function of one or more input parameters. The display module can also display a schematic image of free space that has been searched for and found by the search module and/or display a front view and/or a rear view of a predetermined rack that has been searched for and found by the search module. The display module can also display power that is available for assets to be attached to a predetermined rack, a total threshold value of power available for assets to be attached to the predetermined rack, an amount of remaining power available for assets to be attached to the predetermined rack and/or an amount of power currently being used by assets currently attached to the predetermined rack.

In this manner, the system can be used as part of a process for tracking the installation, movement, additions and changes of assets within one or more networks that are part of an organization, company, government agency and the like.

### BRIEF DESCRIPTION OF THE DRAWINGS

FIG. 1 illustrates a network asset documentation process according to an embodiment of the present invention;

FIG. 2 illustrates an example database schema for use with an embodiment of the present invention;

FIG. 3 illustrates an asset life cycle model according to an embodiment of the present invention;

FIG. 4 illustrates a schematic diagram of a search screen according to an embodiment of the present invention;

FIG. 5a is an example implementation of a portion of a search screen according to an embodiment of the present invention;

FIG. 5b is an example implementation of a different portion of the search screen shown in FIG. 5a;

FIG. 6 is an example implementation of a search screen results search according to an embodiment of the present invention;

FIG. 7a is an example implementation of a portion of an asset record screen according to an embodiment of the present invention;

FIG. 7b is an example implementation of a different portion of the asset record screen shown in FIG. 7a;

FIG. 8a is an example implementation of a portion of a room diagram screen according to an embodiment of the present invention;

FIG. 8b is an example implementation of a different portion of the room diagram screen shown in FIG. 8a;

FIG. 9 is a schematic diagram of a rack according to an embodiment of the present invention;

FIG. 10a is an example implementation of a portion of a front view of a rack diagram screen according to an embodiment of the present invention;

FIG. 10b is an example implementation of a different portion of the front view of the rack diagram screen shown in FIG. 10a;

FIG. 10c is an example implementation of a different portion of the front view of the rack diagram screen shown in FIG. 10a;

FIG. 11a is an example implementation of a portion of a back view of a rack diagram screen according to an embodiment of the present invention;

FIG. 11b is an example implementation of a different portion of the back view of the rack diagram screen shown in FIG. 11a;

FIG. 11c is an example implementation of a different portion of the back view of the rack diagram screen shown in FIG. 11a;

FIG. 12 is an example implementation of a different portion of the network subsystem screen;

FIG. 13a is an example implementation of a portion of an asset record change screen according to an embodiment of the present invention;

FIG. 13b is an example implementation of a different portion of the asset record change screen shown in FIG. 13a;

FIG. 14 is an example implementation of a move asset screen according to an embodiment of the present invention;

FIG. 15a is an example implementation of a portion of an add asset screen according to an embodiment of the present invention;

FIG. 15b is an example implementation of a different portion of the add asset screen shown in FIG. 15a;

FIG. 16a is an example implementation of a portion of a free space reservation screen according to an embodiment of the present invention; and

FIG. 16b is an example implementation of a different portion of the free space reservation screen shown in FIG. 16a.

### DETAILED DESCRIPTION OF THE PREFERRED EMBODIMENT

The present invention provides a system and process by which an individual or organization can document and monitor the various assets that comprise one or more of their information technology networks, computer networks, or other types of networks. As such, the present invention has utility as an asset management tool.

In general terms, the system comprises the steps of gathering and verifying asset information, loading the information into a database, and accessing the database to enable viewing of at least one graphical depiction of the relationships among the assets and/or the physical locations of the assets. The invention allows for easy access to data by compiling information related to a variety of networked assets into a cohesive repository.

The term “network”, as used hereinafter, refers to the various assets which comprise a network, as well as to the various interconnections between these assets. The interconnections may be treated as a distinct type of asset. As mentioned previously, the logical connection or “link” between two devices may actually involve several physical interconnects of different lengths. For example, the link between a given telephone instrument and the private branch exchange (“PBX”) switch to which it is connected may be made up of several different cables: from the phone to the wall jack, from the wall jack to the “phone closet,” from that closet on one floor to the closet on another, and finally from the second closet to the PBX switch itself. Each section of the link from the phone to the PBX can be treated as an asset with physical, logical, technical and business information of its own. The term “network” in this context would refer to the telephone instrument, the PBX switch, and the various cables in between.

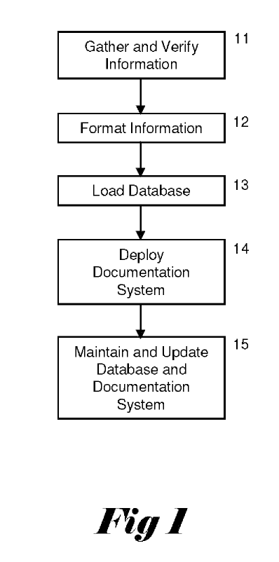

FIG. 1 illustrates the documentation process by which the invention verifies, monitors, and gathers information about a given network. This information may include, but is not limited to: the locations of buildings where the assets are stored, the rooms in these buildings where the assets are stored, the racks and/or other storage locations within these rooms, the contact person for each asset, the type of each asset, serial numbers, IP addresses, and warranty dates for each asset, the weight, dimensions, and power consumption of each asset, the dimensions of the rooms and racks where the assets are located, and the maximum load of these racks. Different types of information may be collected depending on the network type, and the users' needs.

In step 11, a variety of available information about the network, including some of that described above, is gathered. Depending on the amount of information readily available, this could be, but is not limited to, a manual process including tasks such as conducting a physical inventory, obtaining and verifying diagrams, reports and manufacturer specifications in electronic and/or printed form, and interviewing key members of the network team. For modern networks comprised of electronically interconnected assets, some, but not necessarily all, of the information could be obtained through an “auto-discovery” process. In such networks, an application can be run that queries some or all devices on the network using a standard communication protocol such as a Simple Network Management Protocol (SNMP). Each asset that supports SNMP will respond to the query with information about itself. In practical situations, gathering all the information about the network will involve manual investigations of the actual assets and the review of hard copy and electronic inventory records. During the course of gathering this information, the various data may be cross-referenced and/or double checked to verify that the information is correct.

In step 12, the verified information is formatted such that it can be loaded into a relational database. The relational database could be any of a number of commercially available databases, such as Microsoft Access®, available from Microsoft Corporation of Redmond, Wash.; Oracle® from Oracle Corporation of Redwood Shores, Calif.; DB2 from IBM Corporation of Armonk, N.Y.; and the open source relational database MySQL from MySQL AB of Uppsala, Sweden.

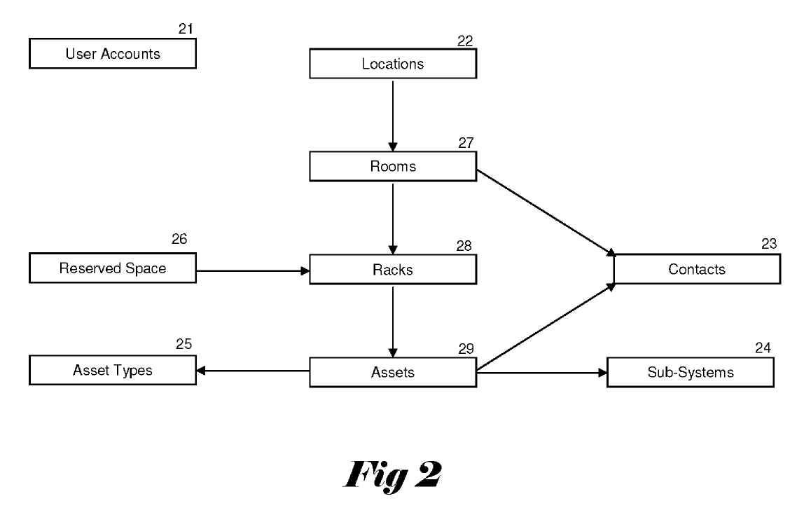

In step 13, the information is loaded into the relational database using an appropriate schema. The schema defines the relationships among the various types of information that will be documented by the system. Placeholders can be put into the schema in anticipation of information to be provided in the future. An example schema is illustrated in FIG. 2 and will be discussed further below.

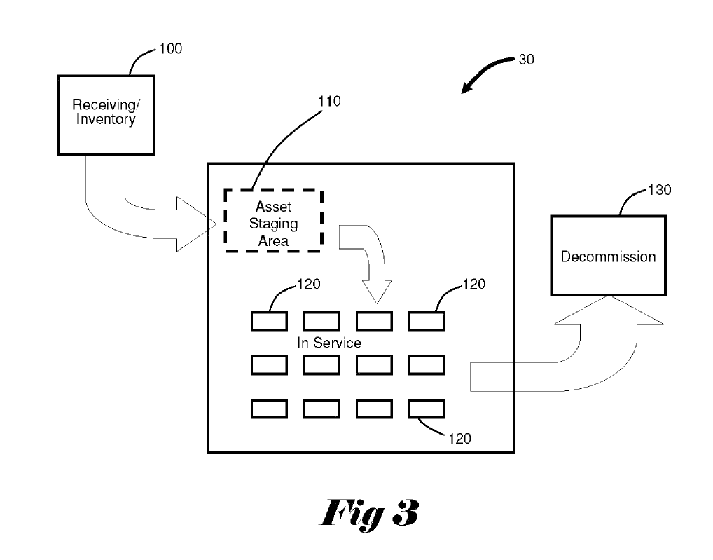

In step 14, the documentation system of the present invention is installed on a computer (not shown) running a web server (such as the open source web server Apache from The Apache Software Foundation in Forest Hill, Md. or the IIS Web Server from the Microsoft Corporation of Redmond, Wash.) to allow end users to access the information with a graphical user interface, which is described below and illustrated in FIGS. 3-13, through a standard web browser such as Internet Explorer® from Microsoft Corporation. This installation of the software on a computer running a web server permits the invented system to be accessed, used and managed from any computer connected to the network, allowing the number of users and administrators to be determined by the businesses' needs alone. The information may also be accessed through a private intranet connection used by the organization managing the assets.

The documentation system serves as more than just a repository of information. As explained below, it aids users in the maintenance and upkeep of the network and the information concerning the network. The system includes functions that facilitate requests to change, move, and add assets. The system can route requests to the next higher approver in the chain of command. The status of these requests can be tracked by the system. The system can be configured so that, if desirable, any requested change, move or addition is not implemented until the appropriate approvals have been granted.

As part of the overall process, a documentation system administrator may be part of the chain of command for requesting and approving changes to the system. This person would be trained on the documentation system functions and would be responsible for maintaining the above described database that contains the physical, logical, technical and business information for each asset that comprises the network, the database hereinafter being referred to as the “asset database”.

The process of maintaining a network performs optimally when the asset database is up to date and reflects the current state of the network. Depending on the size of the network, this may or may not require the full-time role of a documentation system administrator. The overall process can potentially be offered as a service to those companies who do not need a full-time administrator, but want to ensure the network documentation is always up to date. In step 15, the asset database and the documentation system are maintained and updated as necessary. The information contained in the asset database can be easily changed to reflect changes to the users' network.

The documentation system itself comprises software developed for the purpose of displaying information in the asset database in ways that are described and illustrated further below. The exemplary schema illustrated in FIG. 2 is one possible organization of the information contained in the asset database. This example schema contains nine different tables labeled 21 through 29.

The User Accounts table 21 can include information about each user of the documentation system, such as the user login, password, security level, name, phone number as well as the user's preferences for the look and feel of the user interface.

The Locations table 22 can include information about the cities, buildings and floors where assets may be located and the Rooms table 27 can include information necessary to draw a floor plan of each room where assets might be located. This information may include, for example, the dimensions of each room. Alternatively, the floor plan of the room may be derived from externally created maps that have been scanned and uploaded to the system. The Racks table 28 can include information necessary to create a diagram of each rack (or other storage container such as a shelf, table, etc.) that houses the assets being documented. This information may include, for example, the dimensions of each rack, and/or the dimensions of each shelf of each rack. The Racks table 28 can further include information pertaining to the maximum load each rack can carry, and/or the maximum load of each shelf of each rack. In addition, the Racks table 28 can link to the Rooms table 27 and/or the Rooms table 27 can link to the Locations table 22 in order to provide a hierarchical structure of the geography of an organization's network.

Typically a network is logically partitioned into a set of sub-systems. The Sub-systems table 24 can include information necessary to create a schematic diagram of all or part of the network.

The Contacts table 23 can include information about each person who is responsible for an asset. Such information could include the name, address, telephone number and email address of each responsible person.

The Asset Types table 25 can include information about every type of asset in the network including, but not limited to, manufacturer, model number, dimensions, weight, types of logical connections, and number of connections of each type. The Asset Types table 25 can also include items such as the serial number, purchase date, warranty expiration date, IP address, revision number, power consumption, etc. In one embodiment, an Assets table 29 having a collection of all the assets within a user account can link to most if not all of the other tables, either directly or indirectly.

The Reserve Space table 26 can include information about each section of a rack that has been reserved in anticipation of installing a new asset and can contain information such as the size and location of the space in the rack, who is reserving it and why.

The above described schema may be modified or added to depending on the various types of information contained in the asset database, and on the physical and virtual structure of the network.

Once the system has been deployed, for example, on a web server hosting software applications that use data from the asset database, the documentation system of the present invention provides a variety of functions that will be explained below with the aid of exemplary screenshots. As explained, the screenshots are examples included here for illustrative purposes only and are in no way meant to limit the present invention.

Referring now to FIG. 3, a schematic diagram illustrating a macro view of asset flow within an organization, company, etc., is shown. As shown in the figure, one or more assets can be located in a receiving and/or inventory location 100 before being located at an asset staging area 110. It is appreciated that the receiving and/or inventory location 100 and the asset staging area 110 can be one in the same, located within the same room of a building, etc., or in the alternative actually be two separate locations within a building, organization, city, state, etc. After being processed through the asset staging area 110, the one or more assets can be placed in service at a given location 120 until eventually being decommissioned and moved to a decommissioned location 130. During the operating life of the asset, it can be moved from one location 120 to a different location 120, and yet still maintained within the asset inventory and management system such that the exact location, upcoming maintenance date, power usage and the like of the asset are readily and conveniently accessible.

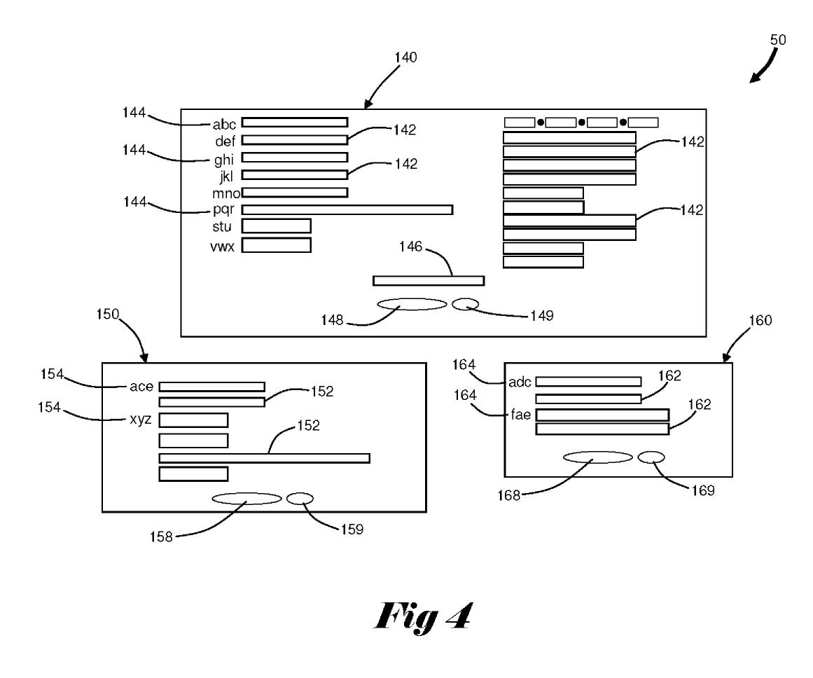

Referring now to FIG. 4, a Search function can allow a user to search the asset database to find assets, spaces or locations that match the user-specified criteria. In particular, FIG. 4 illustrates a schematic diagram of a search screen displayed by a display module is shown generally at reference numeral 40. It is appreciated that the search screen 40 can be part of a search module that affords for searching for one or more assets within a system. In addition, there can be more than one search module or major search category, as illustrated by boxes 140, 150 and 160, on a given search screen 40.

Looking particularly at search module 140, a plurality of input spaces 142 can be provided where a user can input search parameters, the input spaces 142 having identification information or indicia 144 adjacent thereto. The module 140 can also have a submit or search button 148 and/or a clear/start over button 149. An option button 146 can be provided in which a preference such as how many results from the search are displayed in a given table or screen can further be provided. In addition, one or more of the input spaces 142 can be in the form of a “drop down” box or list that allows a user to select one of a plurality of choices for a given search term. In this manner, input parameters such as a location of one or more assets, a contact person associated with one or more assets, an IP address, warranty start/end dates, and the like can be provided in order to search for assets that are stored within the system.

In some instances, the module 150 can include input spaces 152 that afford for input parameters to identify free space where an asset can be stored, attached, and the like. Similar to indicia 144 shown in module 140, indicia 154 can be provided as part of the module 150 to aid a user in supplying input parameters. In addition, a submit or search button 158 and/or a clear/start over button 159 can be provided. In other instances, the module 160 can be part of a reserved space search module in which space that has previously been reserved for an asset can be searched for to identify its location, the room where it is located, the “owner” of the reserved space, and the like. Similar to the modules 140 and 150, input spaces 162 and indicia 164 can be included with a search button 168 and/or a clear/start over button 169. In this manner, free space or previously reserved space can be searched for and/or identified such that a location for an asset can be identified and/or used.

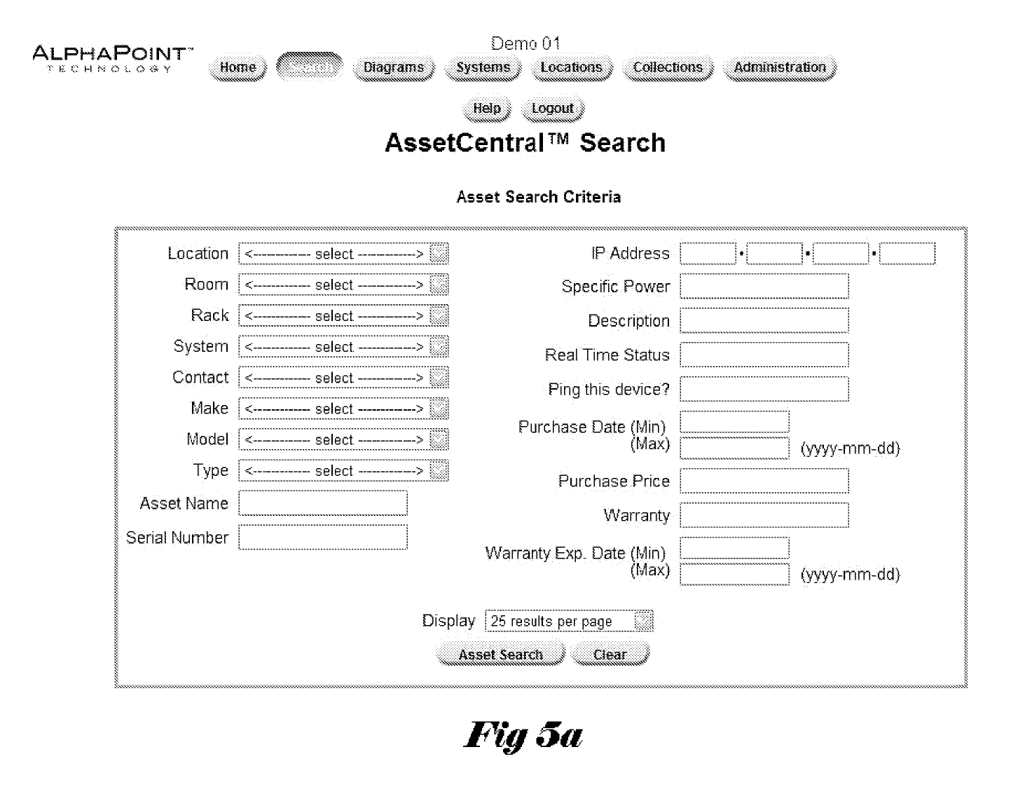

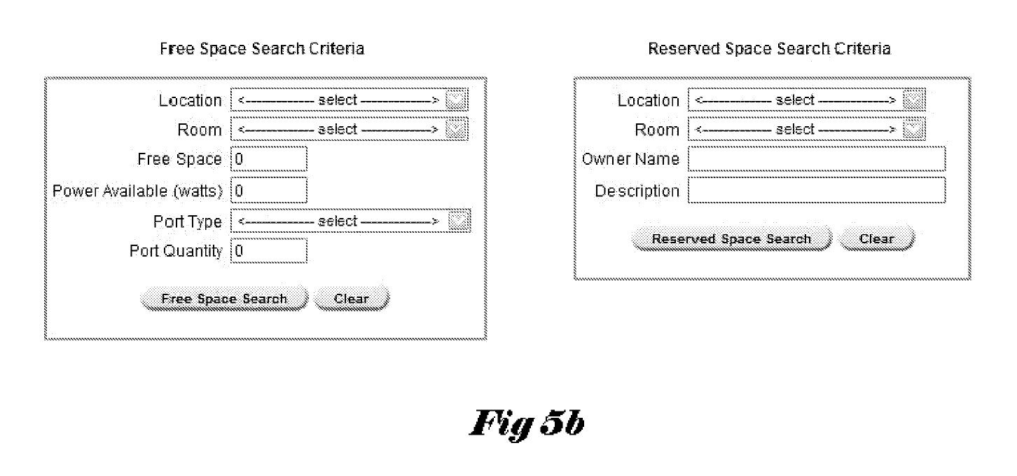

Referring now to FIG. 5a, a screenshot illustrating a portion of one implementation of a search function is shown. On this screen, the user can specify criteria to be used to filter information in the asset database. Examples of search criteria include, but are not limited to: location, room, rack, system, contact person, asset make, asset model, asset type, asset name, serial number, IP address, specific power used by an asset, general description, real time status of an asset, can the device be pinged, purchase date and/or range of purchase dates, purchase price, warranty information, warranty start/end dates and the like. In addition to the default search criteria provided by the software, a network administrator, or other authorized user may alter the search screen so as to modify the search criteria and/or create new criteria.

FIG. 5b illustrates another portion of a search screen in which searching for available free space or currently reserved space can be executed. As shown in the figure, search criteria can include, but not limited to, location, room, amount of free space desired, power available for selected free space, desired port type and desired number of ports. In this manner, a powerful search function is provided to locate free space that fits the requirements of an asset to be moved or added to a network system. In the event that space has been reserved and a user seeks to re-locate the space, for example after an asset has arrived from a supplier and can now be installed as part of the network, the system allows for searching of the reserved space using parameters such as location, room, name of the user that reserved the space (i.e. owner name). description provided by the user and the like.

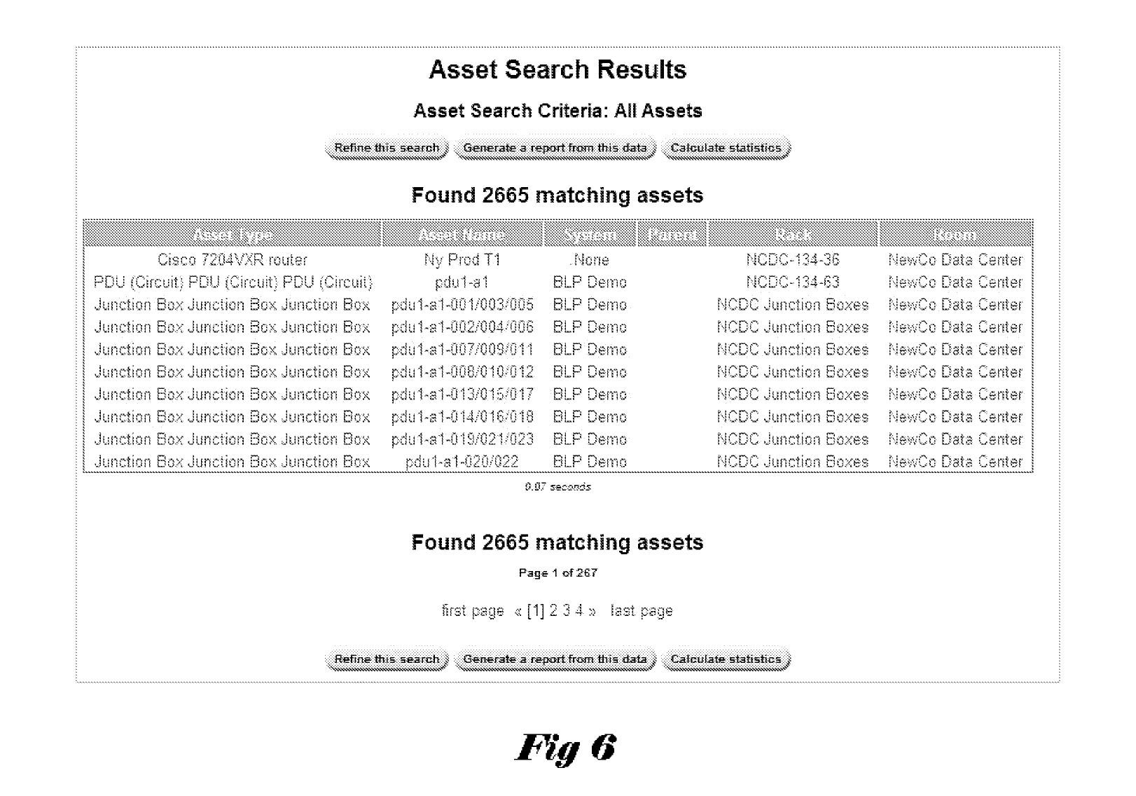

Clicking a desired search button shown FIGS. 5a and 5b screenshot will afford the documentation system to perform the specified search and display the results on one or more search results screens. FIG. 6 is an exemplary screenshot of an example asset search result in which the user can see the assets that match the criteria specified on the Search screen. The user can control the number of search results that appear on a screen and if the number of results exceeds the specified screen limit, the documentation system provides the ability to navigate to the additional results as shown at the bottom of the screenshot.

As will be discussed in further detail below, clicking on various parameters of the search results can link the user to different pages. For example, clicking on the “BLP Demo” entry under the system heading (as displayed in the screenshot of FIG. 6) can lead to a page with a schematic diagram of the virtual layout of the “BLP Demo” system. In one embodiment, a tool tip box can be displayed when the user drags the cursor over the search results. A tool tip box is a box that is displayed in the page or window the user is currently viewing, the box providing the user with information relevant to the asset, space, property, or textual or graphical element over which the cursor has been dragged. The tool tip box may be a preview of some of the information that would be displayed if the user was to click on the same location over which the cursor has been dragged. For example, moving the cursor over the “Cisco 7204VXR Router” asset name entry in the screen shot of FIG. 6 results in a tool tip box with information concerning the Cisco router.

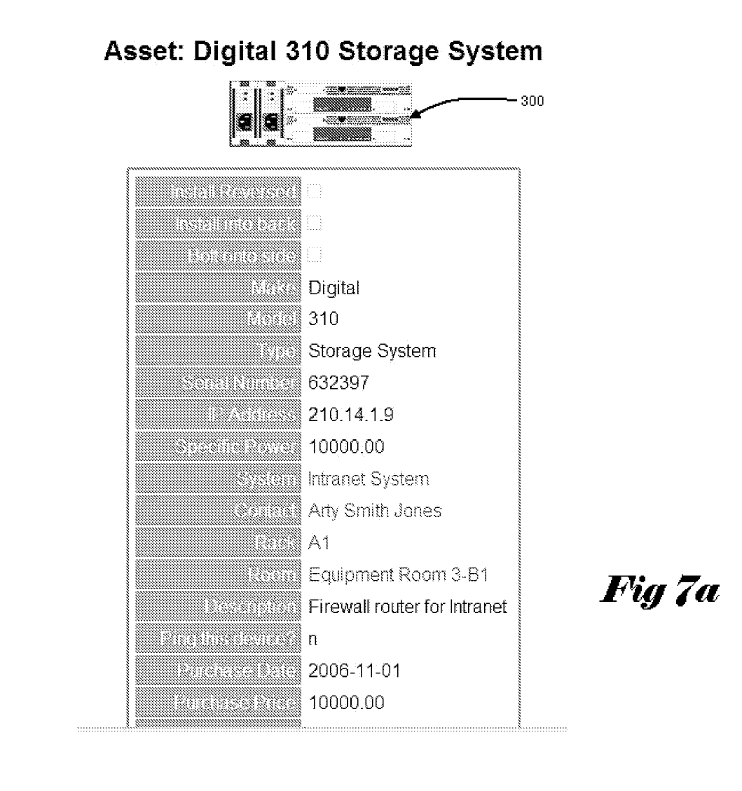

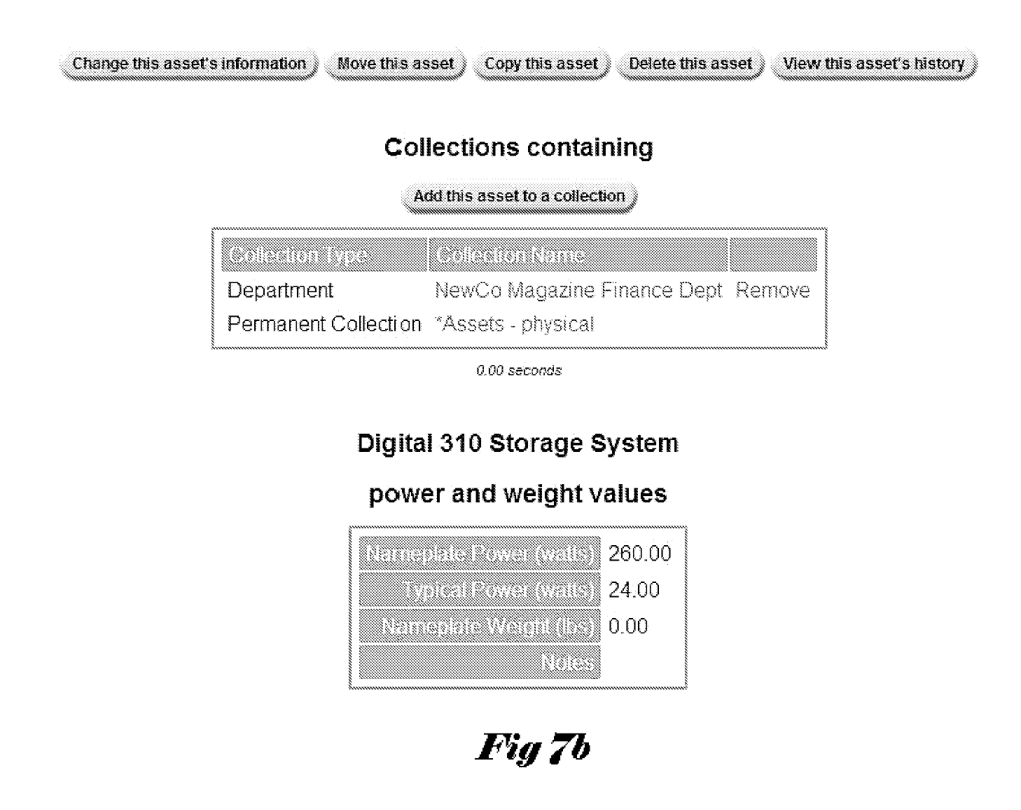

From any search results screen, a user can navigate to the asset record screen for a specific asset by a simple mouse click on the desired asset. For example, FIGS. 7a and 7b illustrate two portions of an exemplary screenshot of a Digital 310 Storage System that was originally displayed on an asset search results screen. This screenshot can display desired textual, business and technical information about an asset that the user is authorized to view, illustratively including at least part of the information discussed above for the asset search screenshot in FIG. 5a. In addition, FIG. 7a illustrates that a digital image 300 of the asset can be provided and FIG. 7b illustrates that buttons for changing information on the asset, moving the asset, copying the information on the asset, deleting the asset, viewing the asset history and adding the asset to a collection can be provided. Information on which, if any, collection that the asset already belongs to can also be provided, as well as electrical power and weight values for the asset.

The screenshot illustrated in FIGS. 7a and 7b can also contain links to graphical information about this asset. Such information can include, but not be limited to, room diagrams, rack diagrams, schematics and block diagrams. As described above, moving the cursor over specific properties displayed in the asset record screen can produce a tool tip box with information about that property. For example, moving the cursor over the contact entry “Arty Smith Jones” can display a tool tip box with Arty Smith Jones' contact information. From the asset record screen, a user can obtain additional information on the particular asset. Two examples are following hyperlinks to a schematic diagram (described later) or to a room floor plan (described next).

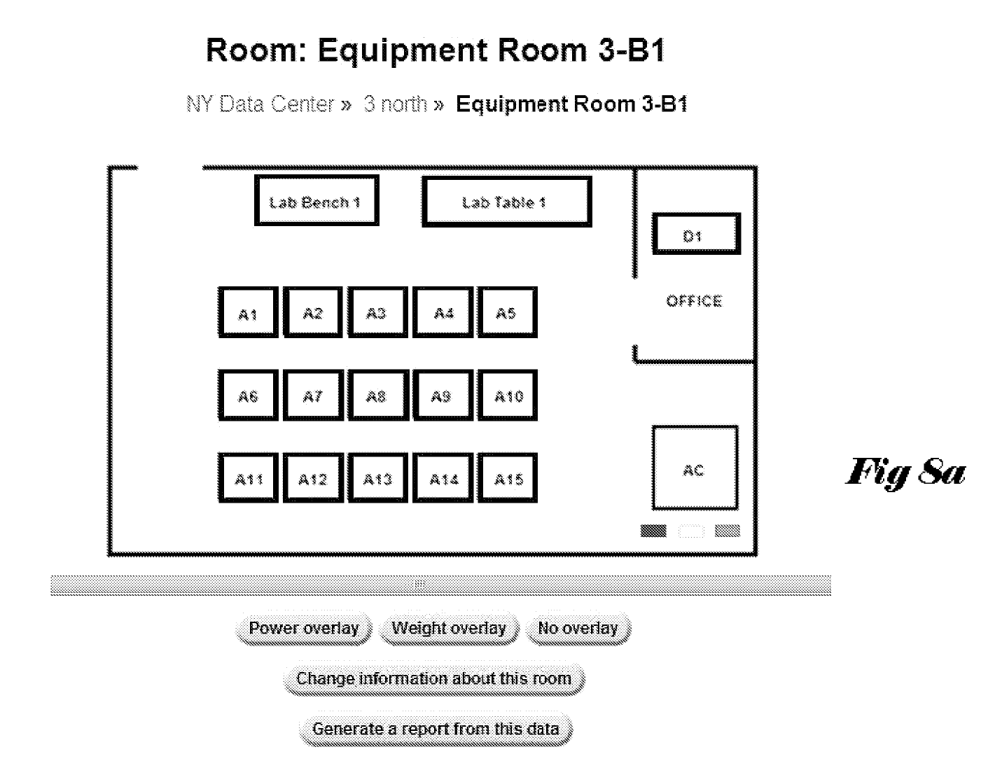

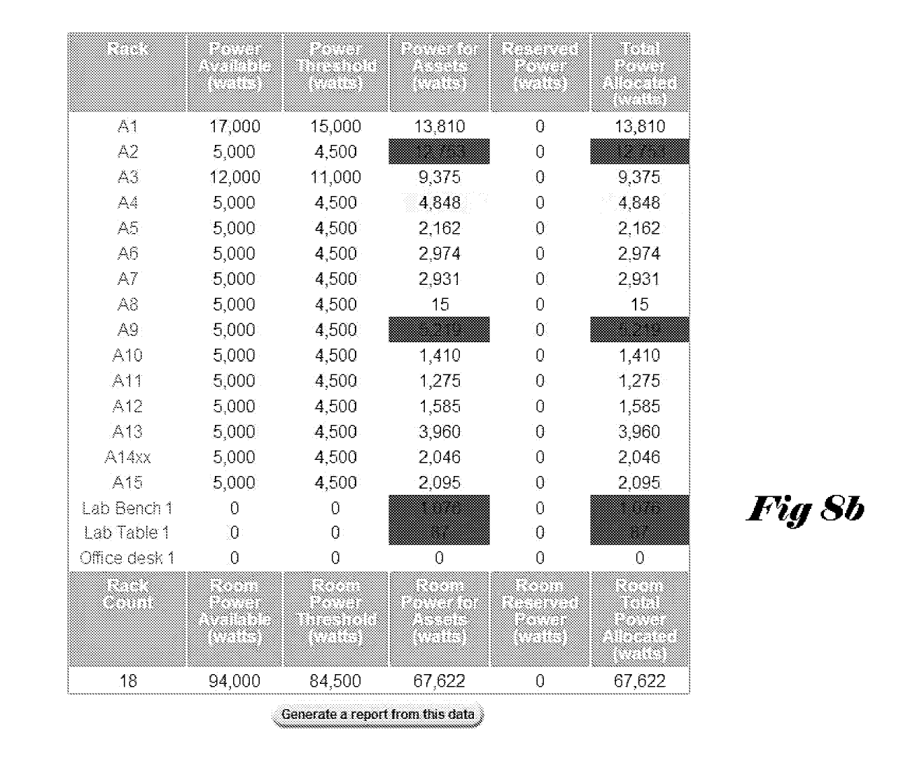

In the alternative, and for illustrative purposes only, clicking on the room hyperlink navigates the system to a room diagram screen as shown in FIGS. 8a and 8b. At the moment of request, the documentation system creates an image of the room's floor plan by accessing information stored in the asset database on the room. Hyperlinks can also be positioned in rack locations on the floor plan, illustratively shown as A1, A2, . . . A15, Lab Bench 1, etc. in FIG. 8a, the hyperlinks leading to a screen illustrating an appropriate rack diagram, bench diagram, etc. The room can contain many racks, benches, tables, etc., and as such, the rack identifier shown in FIG. 7a (A1) can be highlighted when the room screen is provided.

The screenshot of FIGS. 8a and 8b can also provide a listing and/or table of various information on the room and its contents. For example, FIG. 8b illustrates a table having a list of the containers that can hold or store assets, in particular the listing of racks A1, A2, . . . , A15, Lab Bench 1, Lab Table 1 and Office desk 1. In addition, the power available, the power threshold, power currently in use, reserved power and total power allocated can be provide for each container. A summation of each parameter for the entire room can also be provided, along with a button to provide a report on this information.

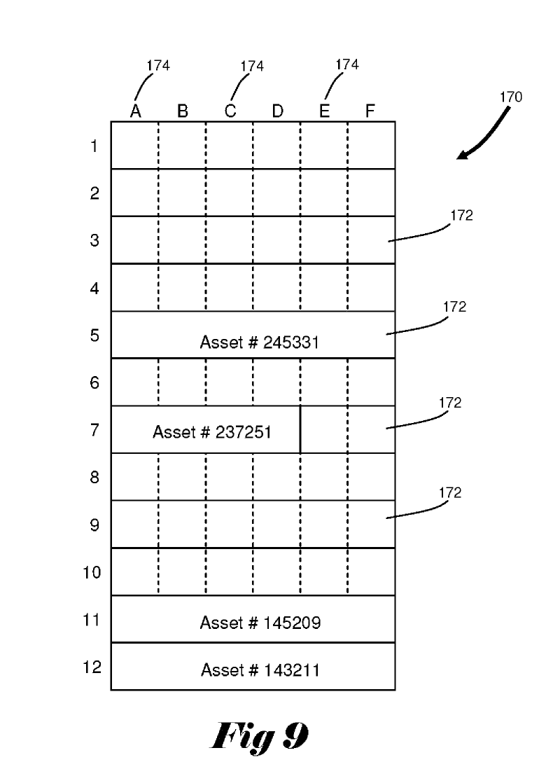

Similar to the screenshot of FIGS. 7a and 7b, and in fact optionally for all screenshots provided by the system, dragging the cursor over a hyperlink of a particular rack can display a tool tip box with information about the rack. Clicking on any rack's hyperlink can bring up another screen with a graphical representation of the selected rack and its contents. Clicking on the highlighted rack will bring up the rack containing the specified asset with that asset highlighted. Referring now to FIG. 9, a schematic illustration of a rack having a plurality of rows 172 and optionally a plurality of columns 174 is provided at reference numeral 170. As shown by the rack 170, assets that are currently attached and/or stored within the rack are displayed with corresponding free space clearly identifiable. As such, if an asset requires, for example and illustrative purposes only, three rows and six columns, then the user can select the space shown as rows 1-3 and columns A-F for the asset location. In addition, this free space or other identified and suitable free space can be reserved for future location and/or use by an asset.

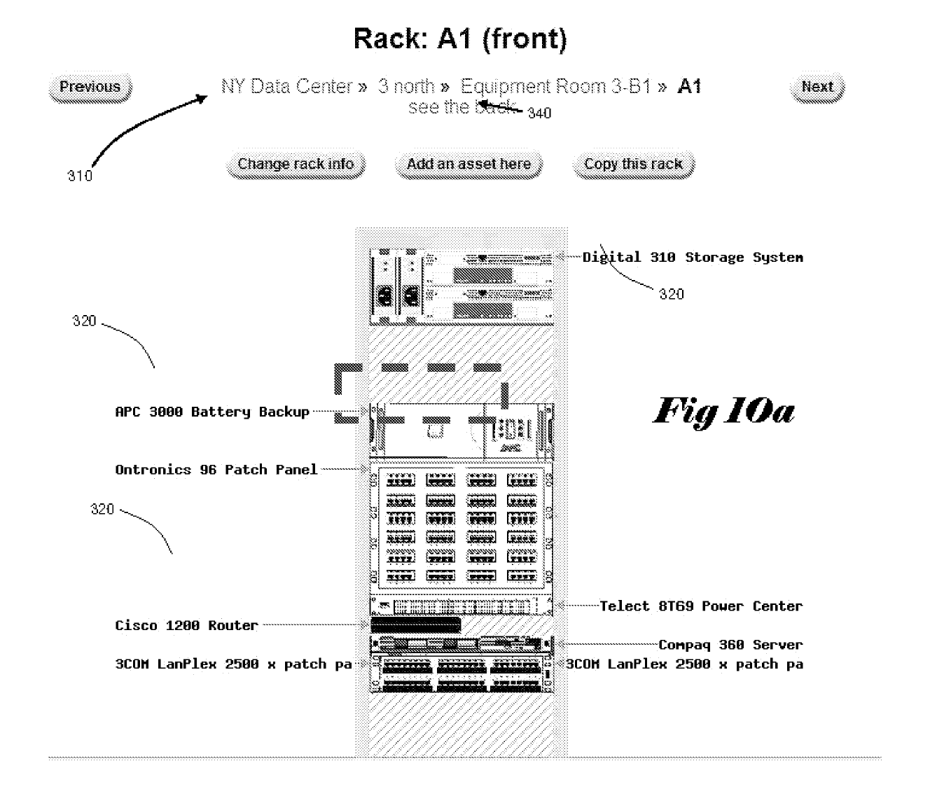

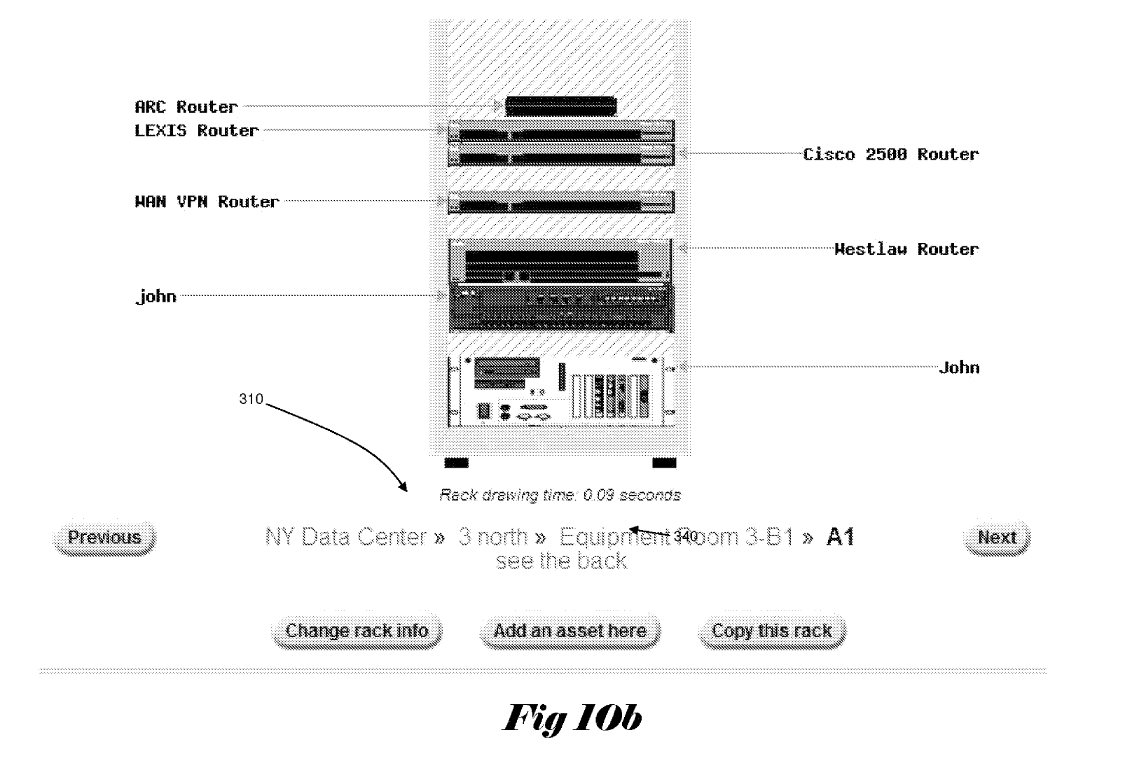

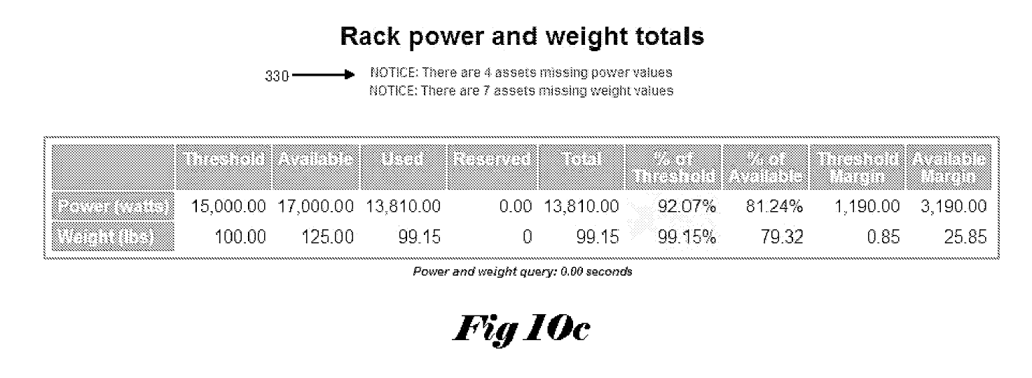

FIGS. 10a-10c illustrates three portions of an exemplary screenshot of a front view for a rack diagram with a highlighted asset shown by the dotted line box around the APC 3000 Battery Backup which can be any type of border, color, etc., that allows a user to easily identify where the particular asset is located within the container. The screenshot can illustrate a graphical diagram of the rack, the assets it currently holds and free space currently not being used. Reserved space can also be shown on the diagram. Clicking on any asset in the rack will lead to an asset record screen for the asset clicked, such as the one shown in FIGS. 7a and 7b. Dragging a cursor over an asset can also display a tool tip box with information about the asset.

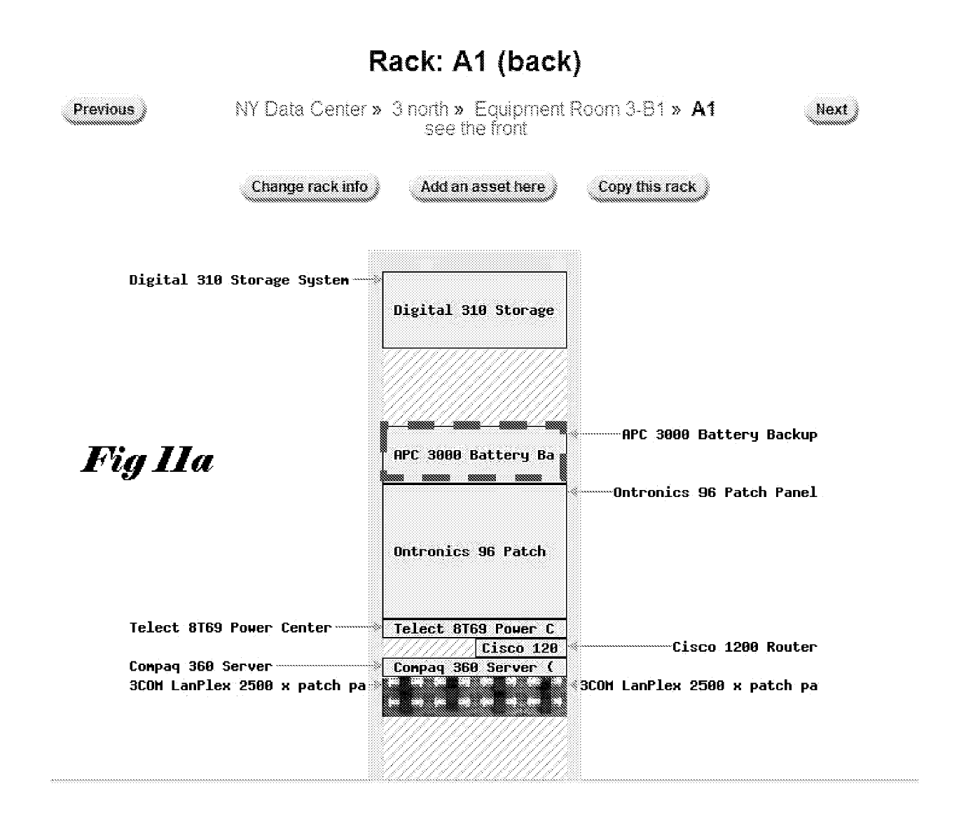

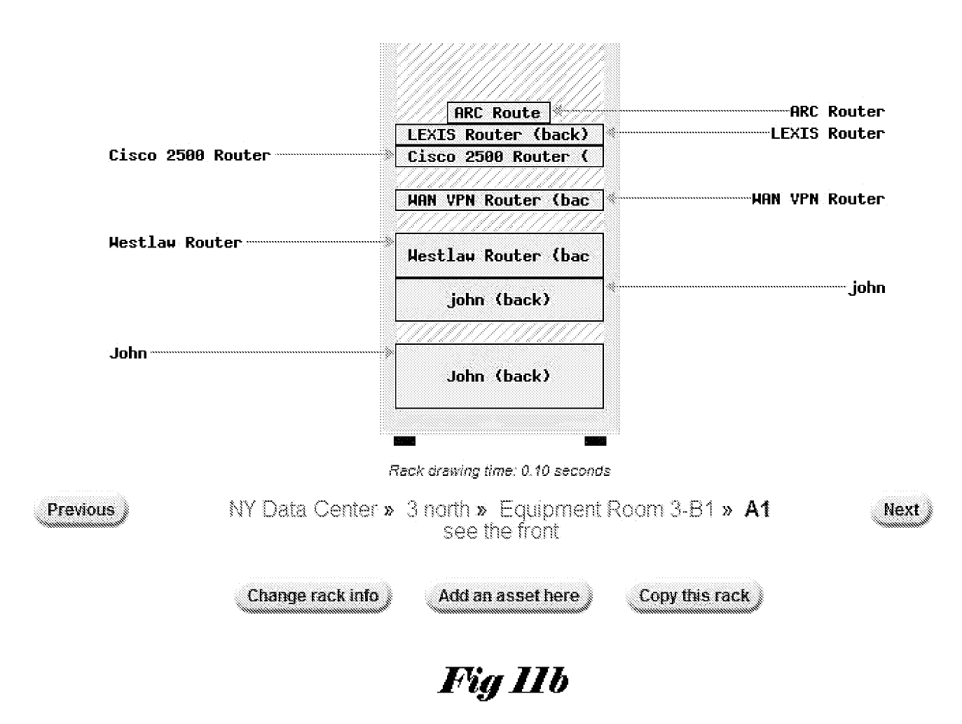

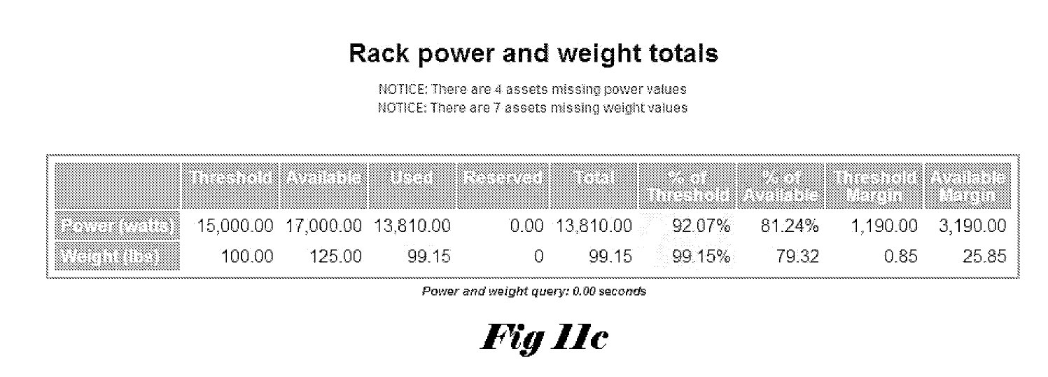

As shown in FIGS. 10a-10c, information on the container 310, labels 320 for assets attached to container and buttons for changing information for the container, adding an asset to the container and copying the container information can be provided. In addition, buttons for returning to a previous screen and/or for going to a next screen that can provide additional information on a previous and/or next container can be present. FIG. 10c also illustrates that information regarding power on the container, total power being used by assets attached to the container, weight that the container can hold, weight currently being held by the container and the like can be provided. The system can also alert a user as to missing information on assets that are attached to the container as shown by the NOTICE labeling shown generally at reference numeral 330 and provide an option to illustrate a back view of the container as shown at 340. FIGS. 11a-11c provide an illustration of three portions for a back view of the container or rack illustrated and discussed above in relation to FIGS. 10a-10c.

It is possible that assets might not be stored in racks, but on shelves, tables, desks, or in any other arrangement available for storing or supporting assets. The documentation system can handle any type of such housing.

In some instances, the graphical diagram of a rack (or table, shelf, etc.) and the assets it contains is not a static image. It can be created dynamically by the documentation system when a user clicks on a link that leads to such a diagram. As such, the documentation system can combine images of each asset contained in the rack itself. If a particular asset has been specified, the asset can be graphically highlighted as well. An “image map” of the entire diagram can also be created as an HTML DIV MAP, which makes the images of each asset into a “hot spot” hyperlink, which when clicked on by a user leads to the asset record screen for the asset. In addition, when a user drags the cursor over the hotspot, a tool tip box can be displayed containing information about the asset.

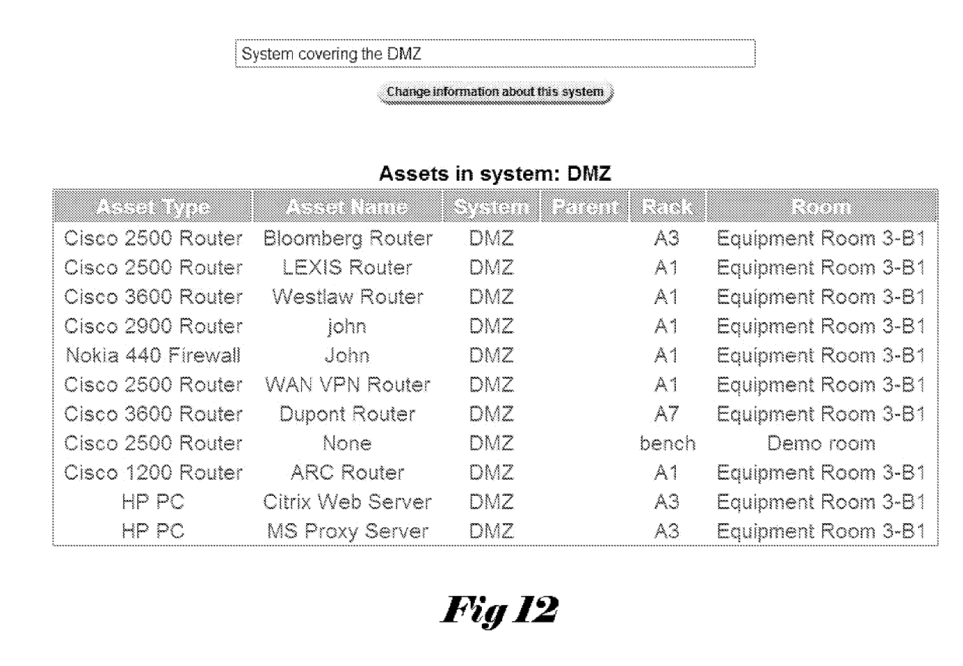

The other example of additional information about an asset is the schematic diagram mentioned previously. By clicking on the system hyperlink in FIG. 7a, the user can navigate to a schematic diagram of the system and/or sub-system containing the asset. Note that diagram is larger than can be legibly displayed on a typical computer monitor and the user can use scroll bars to move the image vertically and horizontally if desired. On this screen, the user can see the logical connections of the specified asset along with a table that provides a listing of information for all the assets that belong to the system and/or sub-system. For example and for illustrative purposes only, asset type, asset name, system and/or sub-system name, a parent system and/or sub-system name, racks and rooms can be provided as shown in FIG. 12. The documentation system of the present invention can create the diagram at the moment of request and highlights the specified asset. An image map of the entire diagram is also created, which provides a hyperlink for each the image of each asset on the schematic, a given hyperlink leading the user to the given asset record screen of the asset. Dragging the cursor over a hyperlink can also display a tool tip box as described above.

The documentation system provides functions to allow users to select an asset and request changes to the information recorded about the asset. The actions taken by the documentation system can be configured to depend on the authorization level of the user making the request.

In most cases, the request will be emailed to the documentation system administrator and to other users who have the authority to approve or deny the change request. The documentation system tracks and stores the responses by those people in the chain of command. Each approval or denial will be stored by the documentation system and also emailed back to the original requestor. Once all appropriate approvals have been granted, the change will be implemented and all those involved will be notified that this has occurred.

In those cases where the user making the request has the appropriate authority to do so, the documentation system makes the change immediately. Once again, the change request will be stored and the original requestor will be notified by email that the change has been implemented.

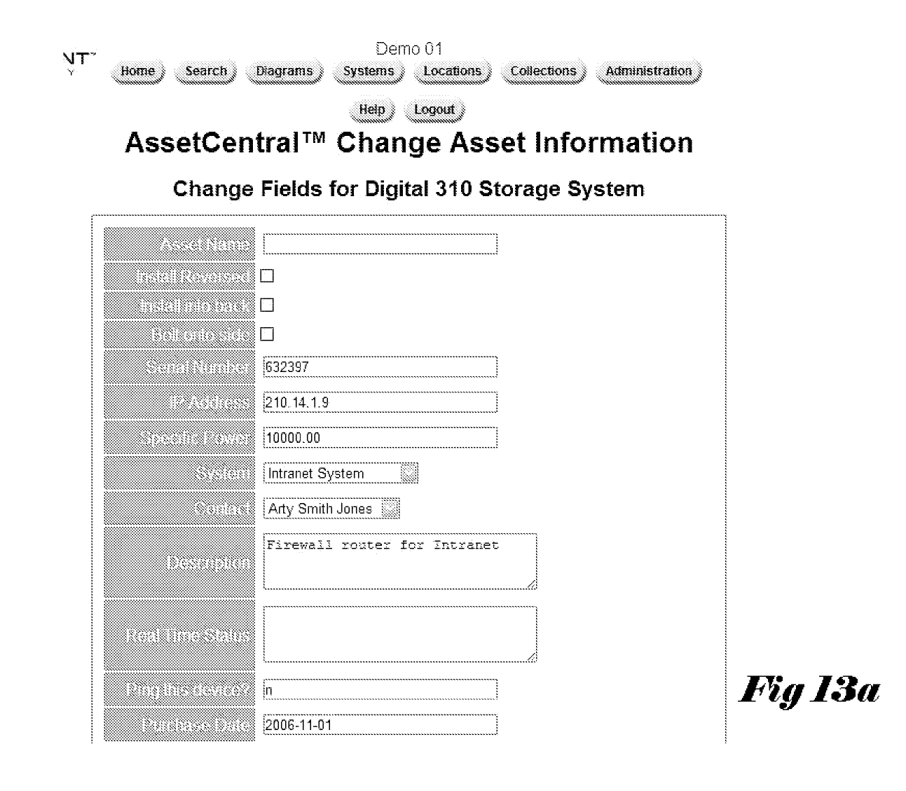

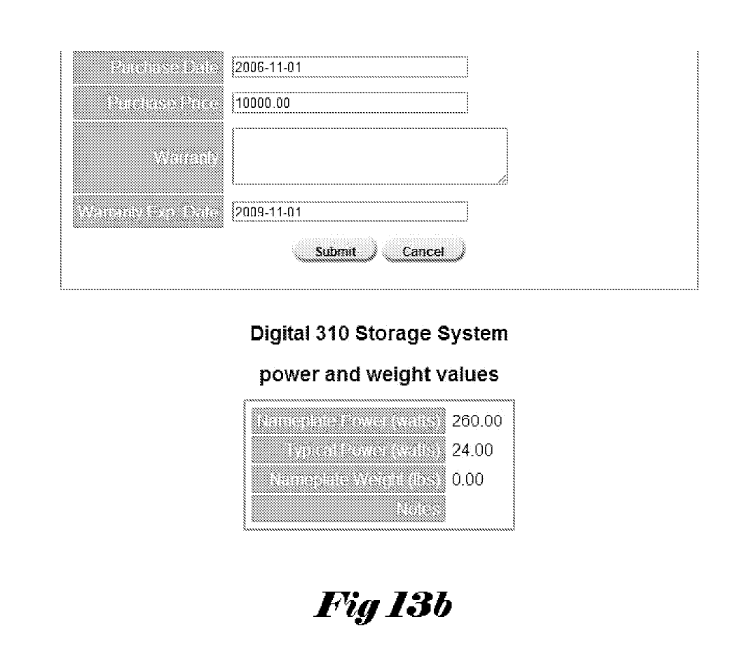

Referring now to FIGS. 13a and 13b, two portions of an exemplary screenshot for one implementation of a change asset information screen are shown. On this screenshot the user can change any of the text information that the user is authorized to change and view power and weight values for the asset. In addition, the system affords for buttons that lead the user to diagrams, systems and/or sub-systems, locations, collections and administrations that are related to the asset.

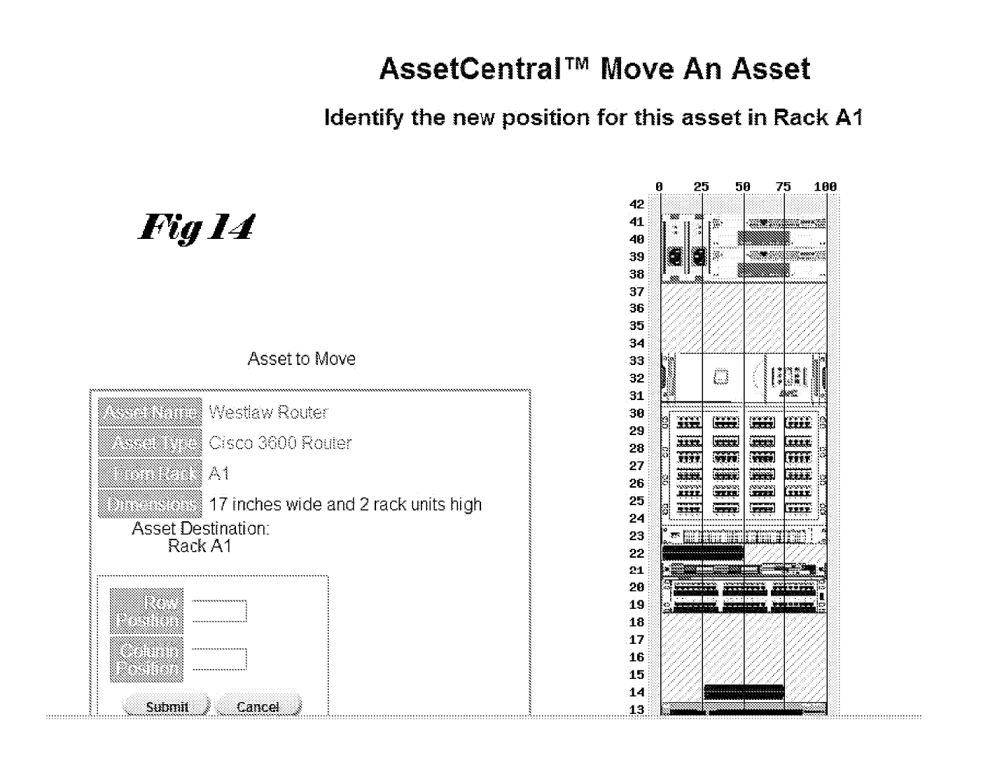

As illustrated in FIG. 7b, the documentation system provides a move this asset button that allows an authorized user to specify the location to which a currently selected asset is to be moved to. Clicking on such a button can result in a move an asset screen as illustrated in FIG. 14. As shown in this screenshot, the rack or container diagram can illustrate partitions of space for the container and allow the user to select a new location for the asset. Note that for a rack as shown in the figure, the user can specify the location in the rack both vertically and horizontally.

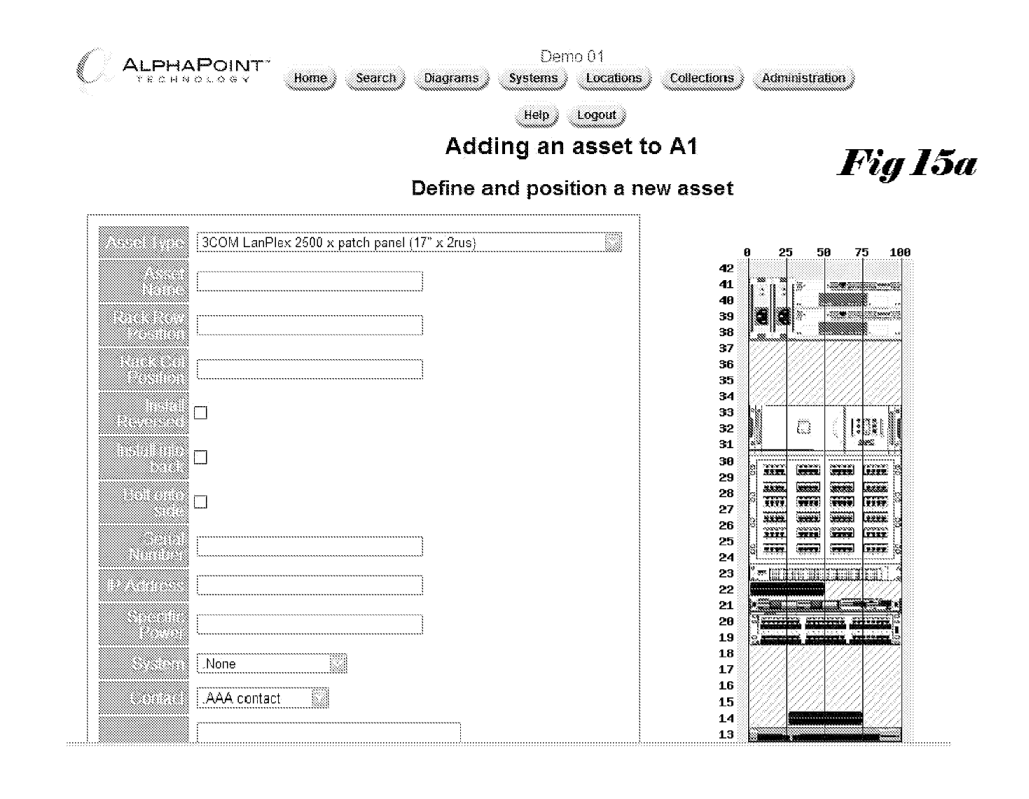

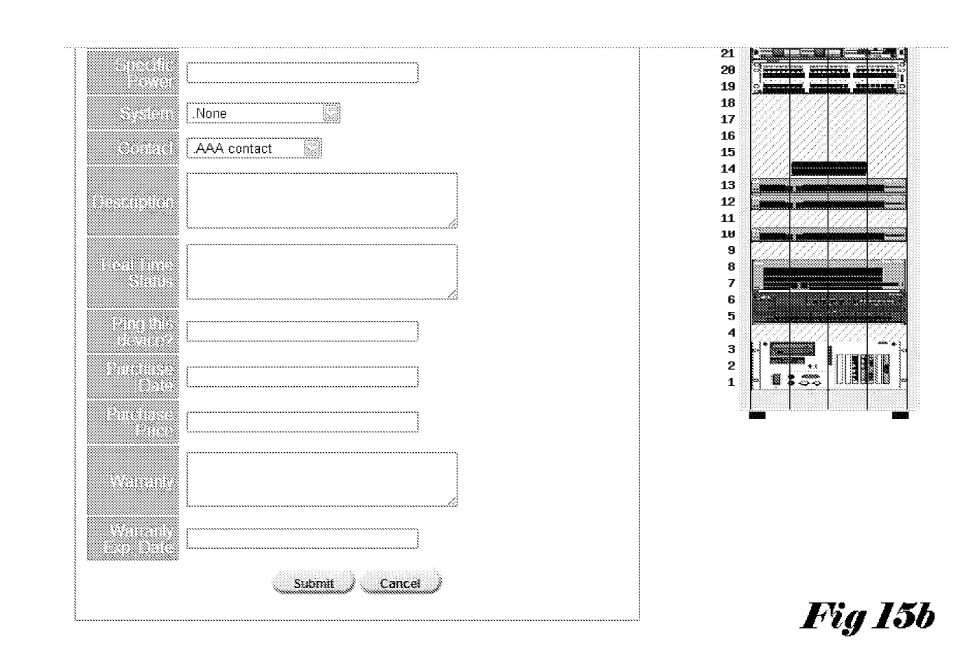

The documentation system also allows users to add assets to the documented network. To add an asset, the user can select the button for adding an asset as illustrated on the screenshot shown in FIG. 10a, the result being a screen as illustrated by two portions of an exemplary screenshot shown in FIGS. 15 and 15b. On such a screen an authorized user can specify all the technical, business, logical and physical information about the asset to be added. All changes to an asset are logged and can be viewed by clicking on a history link such as the view this asset's history button shown in FIG. 7b.

To minimize conflicting intentions, the documentation system preferably provides functions to locate and reserve free space in anticipation of a move, change, or addition. In the system, free space can be treated as an asset itself and a user can locate free space in a rack that meets a desired need using a search function as illustrated by the search screen in FIG. 5b. The user can specify location, room, desired power available required and the like in the search. Other parameters, which can be added by an administrator of the inventive system, can also be used as filters for the free space search.

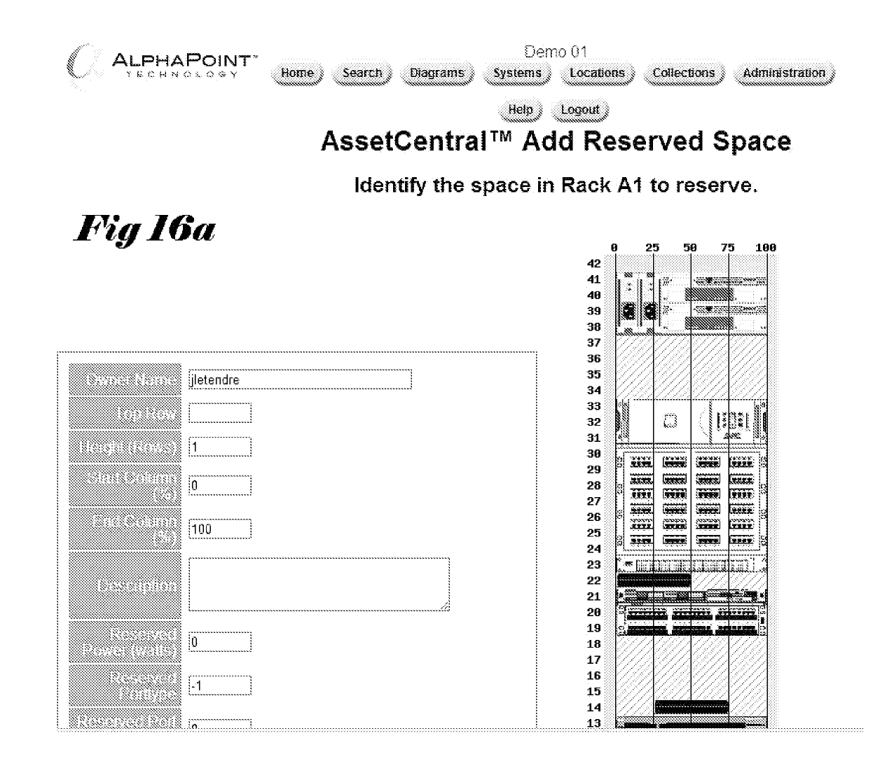

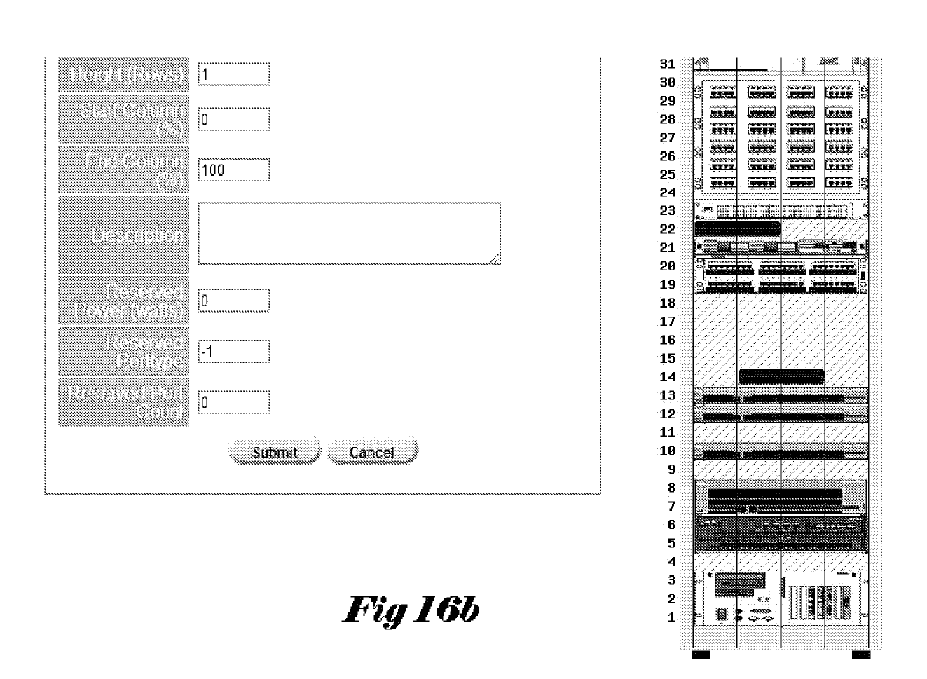

After selecting a rack with suitable free space, the user fills in and submits an on-screen form, an example of which is shown by the screenshot illustrated in FIGS. 16a and 16b. After the reservation has been submitted, the reserved space will be highlighted in the selected rack (not shown). Any user looking at the rack can see that the space is reserved and the reserved space can no longer show up in the results of a free space search. In effect, the system treats reserved space as an asset. By reserving the space, the user is preventing other users from thinking the space is available and this function can help network administrators avoid conflicts and misunderstandings. By clicking on a reserved space any user can view information about the reservation including who reserved the space and for what reason. This information may also be provided through a tool tip box, displayed when a user drags the cursor over an image of the reserved space.

When a user is ready to add an asset to the asset database, they can search for free space as described above. Alternatively, a user can search for space that was reserved previously, by using the search module shown FIG. 5b. If the user searches for and selects space that was reserved previously, the user will be brought to a screen similar to one illustrated in FIGS. 15a and 15b, where the user can add the asset into the reserved space of that rack.

The documentation system and process of the present invention allows users to create a report with information extracted from the asset database. On such a screen the user can select fields to be included in the report. The documentation system creates a comma-separated values (CSV) file, which the user can save on their local machine, allowing the user to print the report or to manipulate the data in the report using another application, such as a word processor or a spreadsheet tool. A CSV file is the most common format to export database records and can be imported by most computer applications.

After the documentation system has been deployed for the first time for a given network, the overall process moves into the maintenance phase. From here on, any moves, additions or changes to the network are preferably entered into the system to keep the database up to date with the actual state of the network.

One process that can be used to maintain an up-to-date asset database is to require the person who actually implements a physical change to the network to fill in the appropriate form on the documentation system, for example using the change asset information module or screen (FIGS. 13a and 13b), move an asset module or screen (FIG. 14) or adding an asset screen or module (FIGS. 15a and 15b). The form is automatically emailed by the documentation system to the documentation system manager, who the updates the asset database accordingly.

For most types of networks, performing and recording a change is a manual process, much like doing a physical inventory. As part of the overall process of keeping the documentation up to date, a random audit may be done periodically to confirm the integrity of the asset database. For networks that can communicate with the constituent devices, the inventory could be done automatically.

For example, computer network devices that support a network management protocol such as SNMP can participate in an automated inventory process. Any network management software application that supports SNMP, for example HP Openview from Hewlett-Packard Corporation of Palo Alto, Calif.; CiscoWorks from Cisco Systems of San Jose, Calif.; or WhatsUp from Ipswitch of Lexington, Mass. could communicate with the SNMP agent in each active device. Gathering information from all responding devices would provide an inventory of the SNMP enabled devices. Comparing the results from two different such inventories would provide insight into new devices that were added, old devices that were removed, and old devices that have changed in some way that the agent can detect (e.g., a change in IP address). This scheme can be used to augment a sample physical audit to used to confirm the integrity of the asset database.

For those networks that can communicate with constituent devices, the real-time status of those devices can be queried on demand or periodically. The documentation system will provide a mechanism to perform such real-time status queries and display the results.

The system includes a variety of calculation tools to help monitor various aspects of the network. For example, the system can calculate the total estimated power consumption of a rack, a room, or any other subset of the network. This information may be displayed in a calculation results screen. In a preferred embodiment, the amount of total power available for the rack, room, or other subset of the network is inputted during the documentation process, or calculated as a result of information entered during the documentation process. An authorized user can set a threshold power consumption level, corresponding to a certain percentage of this total power available. This percentage can be entered and modified by the network administrator or other authorized user.

Upon a request, the system will add the estimated power consumption for each of the assets in the subset of the network that is being queried. If this power consumption exceeds the threshold power consumption level set for that particular network subset, the user and/or administrator will be notified. This notification may take the form of an email, and/or highlighting the total power consumption on the calculation results screen. In addition, the calculation results screen may display the individual estimated power consumption for each individual asset belonging to the subset on which the calculation is being made.

This process need not be triggered only by a user's request; rather, the system is capable of automating this monitoring process. If for example, the addition of a new asset to a particular rack causes the power consumption for that rack to exceed the designated threshold power consumption of that rack, the user making a network modification request (adding or moving an asset) can be notified.

Similar calculations and monitoring methods may be executed for other quantifiable properties of a network subset. For example, the total weight of the assets in a rack can be calculated, and monitored to ensure that they do not exceed a maximum weight that the rack is designed to support. Another example of such a calculation is summing the total cost of the assets in a subset of the network. In addition to the above described calculations, the system allows for a network administrator, or other authorized user, to use and execute his own set of algorithms using quantifiable asset and network properties as inputs.

The system also allows for graphical representation of the properties of a subset of the network. For example, the system is operable to display an image of the floor plan of a room, wherein each rack is colored according to what percentage of the total power available to that rack is estimated to be consumed. In one embodiment, racks that are consuming a higher percentage of their total available power are colored darker shades of red and those consuming lower percentages are colored darker shades of blue. Such a graphical representation may be made for other subsets of the network, as well as for other properties of a network. For example, the system is operable to display a schematic of a building, wherein the weight of the assets carried in each room is colored according to the maximum allowable weight allowed for that room.

Similarly, the system is operable to display multiple properties of a network subset in a single graphical representation. This may be accomplished in a variety of manners. For example, the power consumption of a rack may be indicated by shading its image, while the weight may be indicated by increasing or decreasing a height dimension of each rack image. These above described graphical representations are generated dynamically upon the request of a user, and are particularly helpful when network modification requests are being made. If for example, a user is deciding which rack of a room to add an asset to, he may find it helpful to look at a diagram displaying which racks are both consuming low amounts of power and contain lots of available space.

Although the above described calculations and graphical representations may normally be based off data derived from manufacturer specifications, the system is operable to interact with independent monitoring equipment and/or software, so as to instead use real-time data. The system can perform as a central repository for links to independent monitoring software and access to their functions. For example, instead of using the estimated power consumption from a manufacturer specification as the basis for power calculations and graphical representations, the system may instead interact with power monitoring equipment or software to receive the actual real-time power consumption of a subsystem of a network. This actual real-time power consumption can be used to make further calculations and graphical representations.

One advantage of the present system is the ease it provides in viewing information about particular assets, and navigating between various sets of information. To help accomplish this end, the system further comprises a Hot Spot Editor. The Hot Spot Editor is a feature which allows users to create links between various graphical representations and/or information sets. As described above, a link may be positioned, for example, at a rack location in the floor plan screen of a room, the link leading to the rack diagram screen of that rack. In one embodiment, the Hot Spot Editor incorporates a tool allowing an authorized user to create an outline around the asset or space where they want the link to be placed. Each asset or space may be assigned an identification number, and by entering this identification number in the Hot Spot Editor, the link can be customized so as to navigate the user to a screen containing information about the asset or space corresponding to that identification number.

The system can provide for ease in creating multiple hyperlinks in a single instance. For example, if a user wishes to create links in the floor plan of a room, leading to the rack diagram screen of each of a plurality of adjacent racks, the user can accomplish this by dragging the outline tool over the plurality of racks. Upon entering a starting identification number, the system will automatically increment the number to correspond to the identification number of each adjacent rack that is being outlined. Alternatively, the system may automatically correlate assets or spaces with identification numbers without the need for a user to enter such. In addition to this Hot Spot Editor, the system may further comprise a Tool Tip Editor operable to customize the information displayed in the aforementioned tool tip boxes.

As the documentation system and process is predicated on the information contained in the asset database, steps are preferably taken to protect the integrity of the information. To do this, the documentation system has a multi-level security system, which allows the documentation system administrator to manage which individuals have read or write access to which pieces of information.

As such, users can see and change only those items of information for which they have read/write access. In general, users will have read-only permission for some information and read/write permission for a subset of that information.

Alternatively, and as part of the overall process, the database can be backed up and saved offsite as part of the comprehensive disaster recovery plan.

Although the invention has been described and illustrated in the foregoing exemplary embodiments, it is understood that the present disclosure has been made only by way of example, and that numerous changes in the details of construction, combination and arrangement of processes and equipment may be made without departing from the spirit and scope of the invention. As such, the scope of the invention is provide by the scope of the claims.

I claim:

1. A system for asset inventory and management comprising:
a data input module operable to input asset data, location data and container data, said location data and said container data associated with said asset data;
an asset storage database having said asset data and said location data;
a search module operable to search for and select at least part of said asset data and said location data as a function of an input search parameter;
a display module operable to display said at least part of said asset data and said location data selected by said search module.

2. The system of claim 1, wherein said search module is operable to search for at least one of an asset, free space and reserved free space.

3. The system of claim 1, furthering comprising a reserve free space module operable to reserve at part of said free space searched for and found by said search module.

4. The system of claim 1, further comprising one or modules selected from the group consisting of a diagram module, a sub-systems module, a location module, a collection module, a preference module, a report module and a statistics module.

5. The system of claim 1, further comprising a connectivity module operable to display a plurality of assets connected to each other and at least one link between at least two of said plurality of assets.

6. The system of claim 1, wherein said asset data is selected from the group consisting of computer equipment data, telecommunication equipment data, free space data and reserved space data.

7. The system of claim 3, wherein said asset data is selected from the group consisting of asset name, asset make, asset model, asset type, number of slots, asset serial number, asset IP address, specific power used by an asset, system an asset belongs to, contact name for an asset, contact phone number for an asset, contact email for an asset, rack where an asset is located, room where an asset is located, parent asset of an asset, location of an asset, description of an asset, real time status of an asset, ping information for an asset, purchase date for an asset, purchase price for an asset, lease information for an asset, maintenance information for an asset, warranty information for an asset, warranty expiration date for an asset, asset ID and combinations thereof.

8. The system of claim 1, further comprising a technical business rule operable to define whether or not a second asset type can be nested within a first asset type.

9. The system of claim 8, wherein said technical business rules define which of one or more asset types can be inserted within a given slot of at least one of an asset and a container.

10. The system of claim 8, wherein said technical business rules define which of one or more link types can be inserted within a given slot of an asset.

11. The system of claim 8, wherein a first asset type is selected from the group consisting of a computer, a server, a router, a printer, a copier and a telephone.

12. The system of claim 8, wherein a second asset type is selected from the group consisting of a control unit device, an arithmetic/logic unit device, a memory device and an input/output device.

13. The system of claim 1, wherein said location data is selected from the group consisting of a receiving location, a storage location, an inventory location, a decommissioned location, a building, a floor within a building, a room on a floor and a rack within a room.

14. The system of claim 1, wherein said container data is selected from cabinet data, rack data, predefined floor space data, freestanding desk data, bench data and table data.

15. A process for tracking of asset installs, moves, adds and changes using the system of claim 1.

16. The system of claim 1, wherein said display module displays a schematic representation of a predetermined rack with predetermined assets attached to said rack.

17. The system of claim 1, wherein said search module is operable to search for and find free space within said system as a function of one or more input parameters.

18. The system of claim 17, wherein said display module is operable to display a schematic image of said free space searched for and found by said search module.

19. The system of claim 18, wherein said display module displays a front view and a rear view of a predetermined rack searched for and found by said search module.

20. The system of claim 19, wherein said display module displays power available for assets to be attached to said predetermined rack.

21. The system of claim 20, wherein said display module displays a total threshold value of power available for assets to be attached to said predetermined rack, an amount of remaining power available for assets to be attached to said predetermined rack and an amount of power currently being used by assets currently attached to said predetermined rack.
